(19) United States
(12) Patent Application Publication
(10) Pub. No.: US 2025/0298293 A1
(43) Pub. Date: Sep. 25, 2025

(54) Modular Mount For Video, Audio and Lighting Equipment

(71) Applicant: Anthony James Franco, Monrovia, CA (US)

(72) Inventor: Anthony James Franco, Monrovia, CA (US)

(21) Appl. No.: 18/612,206

(22) Filed: Mar. 21, 2024

(51) Int. Cl. G03B 17/56; F16M 11/12

(52) U.S. Cl. CPC G03B 17/561; F16M 11/128; F16M 2200/065; F16M 2200/066

(57) ABSTRACT

A modular mount for mounting a video cameras and other equipment to a wall, including (1) a base assembly, including a wall bracket used to attach the modular mount to a wall, and a primary tube, attached to the wall bracket, and (2) and a head assembly, including a secondary tube that fastens to the primary tube, and a head, attached to the secondary tube, including a pan attached to the secondary tube, enabling a video camera and any other equipment to mount to the underside of the pan. and a lid that covers the pan.

### BACKGROUND OF THE INVENTION

The past twenty years has seen the mass adoption of video surveillance. Video systems assist companies to adjudicate worker compensation claims, provide video monitoring and track inventory loss.

Video surveillance is especially beneficial in fulfillment centers due to the increase in shipping volumes. Traditionally, for loading dock surveillance, the most practical video mounting option is to suspend a camera from the roof of a building. For example, in some applications a video camera is mounted on an electrical box looking in the general direction of the loading docks. These video cameras are generally mounted 15-20′ high to not interfere with the forklifts as they pass by.

However, such an approach has multiple problems, such as that (1) technicians typically need to climb a 20 feet or higher ladder or scissor lift every time the camera needs to be serviced or repositioned, and (2) the cameras are typically mounted at least 20 feet from the floor and do not document individual loading docks. Weatherization is another issue that especially affects electrical equipment mounted outside or in exposed areas. Connections between electrical equipment and mounts are especially vulnerable to the effects of weather.

### SUMMARY OF THE INVENTION

The subject invention is a modular mount that may be used to mount a video camera and other devices such as a light or speaker to a wall or ceiling of a building. For example, the modular mount may be used to mount a video camera and a light to a wall in a loading bay to capture uninterrupted footage of loading dock activities. The modular mount offers multiple size settings to position the camera, thus enabling it be positioned out of range of forklifts or other equipment. The modular mount is especially intended for use in loading docks or other facilities that have swinging container doors.

In certain embodiments, the modular mount includes a hinge that enables a head to hinge or rotate away from its standard position when it is pushed or knocked against.

In certain embodiments, the invention is a modular mount for mounting a video cameras and other equipment to a wall, including (1) a base assembly, including a wall bracket used to attach the modular mount to a wall, and a primary tube, attached to the wall bracket, and (2) and a head assembly, including a secondary tube that fastens to the primary tube, and a head, attached to the secondary tube, including a pan attached to the secondary tube, enabling a video camera and any other equipment to mount to the underside of the pan. and a lid that covers the pan.

### BRIEF DESCRIPTION OF DRAWINGS

Non-limiting and non-exhaustive embodiments of the present invention are described with reference to the following drawings. In the drawings, like reference numerals refer to like parts throughout the various figures unless otherwise specified.

FIG. 1 is a front view an embodiment of a modular mount that is mounted on the wall of a loading dock.

FIG. 2A is an isometric view of the modular mount, shown disassembled.

FIG. 2B illustrates the modular mount when fully assembled.

FIG. 2C illustrates enables the head of the modular mount in a rotated position.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, or devices. The following detailed description is, therefore, not to be taken in a limiting sense.

The modular mount enables a camera, light, speaker, or other device to be mounted on its top, bottom or side. For example, the mounted device may be mounted in the top corner of a loading bay to capture uninterrupted footage of loading dock activities. The modular mount can be included in a surveillance system used to protect business owners and employees by documenting through video and/or audio movement of goods, and the various activities associated with loading and unloading goods from trailers and containers. The modular mount offers multiple size settings to position the camera out of range of forklifts and to avoid swinging container doors.

The modular mount enables a camera to be mounted roughly 8′ off the ground as opposed to 20′.

### Operational View Of the Modular Mount

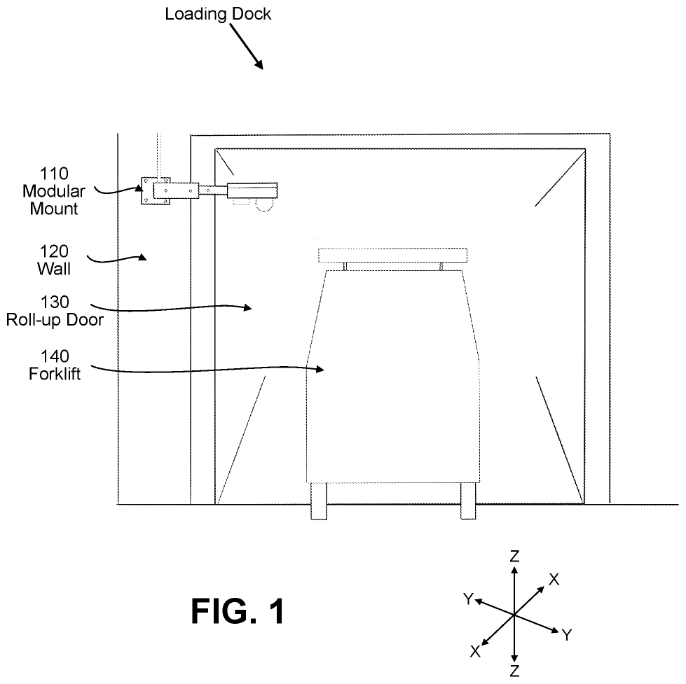

FIG. 1 is a front view an embodiment of a modular mount 110 that is mounted, or attached, on a wall 120 of a loading dock 200. Wall 120 is between adjacent roll-up doors 130. Modular mount 110 may be mounted on an flat surface including inter alia posts, beams, and panels. In this embodiment, modular mount 110 is cantilevered towards the opening of roll up door 130, enabling it to avoid the roll up door track and frame as well as any inward swinging container doors. Modular mount 110 is depicted as providing both a light and a video camera, both pointing downward. Generally, modular mount 110 can mount or house a broad range of electrical fixtures including, inter alia, video cameras, still cameras, lights, microphones and speakers. Based on the selection of the camera (video or still) and the positioning of modular mount 110 the camera can have a very wide field of view, typically from 180 to 360 degrees.

FIG. 1 also depicts the three dimensional coordinate system used herein. The Z dimension value refers to the height from the floor or ground. The Y dimension is the distance away from wall to which modular mount 110 is attached, essentially a distance perpendicular to the plane of the wall. The X dimension refers to the distance from the mounting location along the wall, or along an imaginary line parallel to the wall.

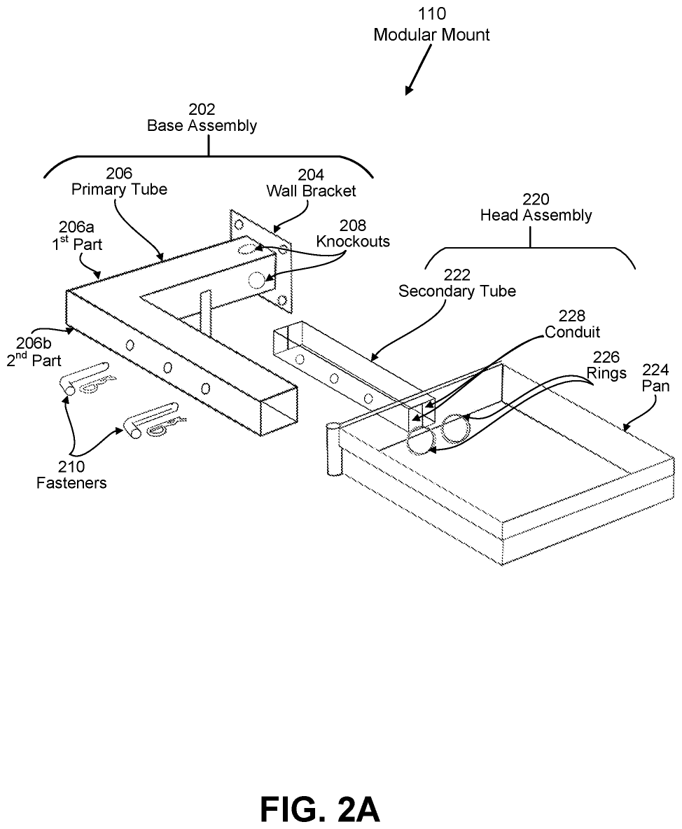

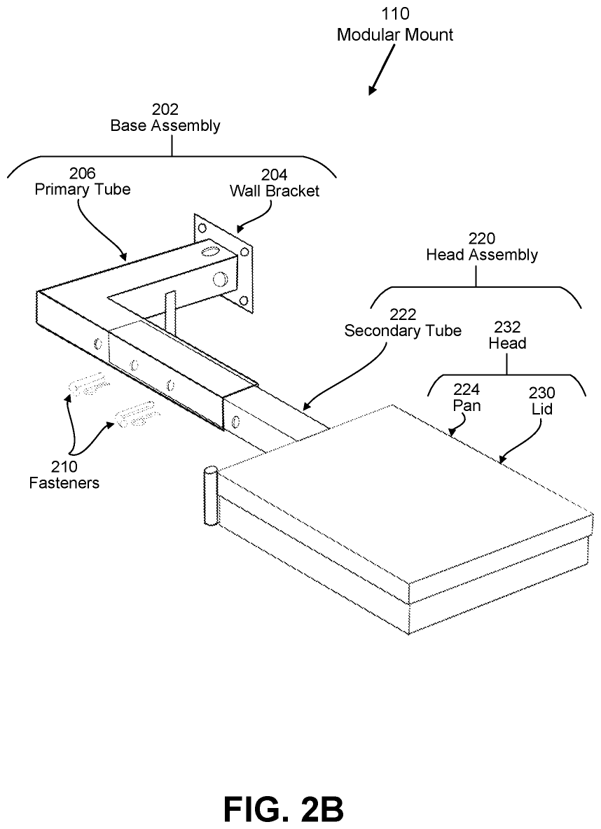

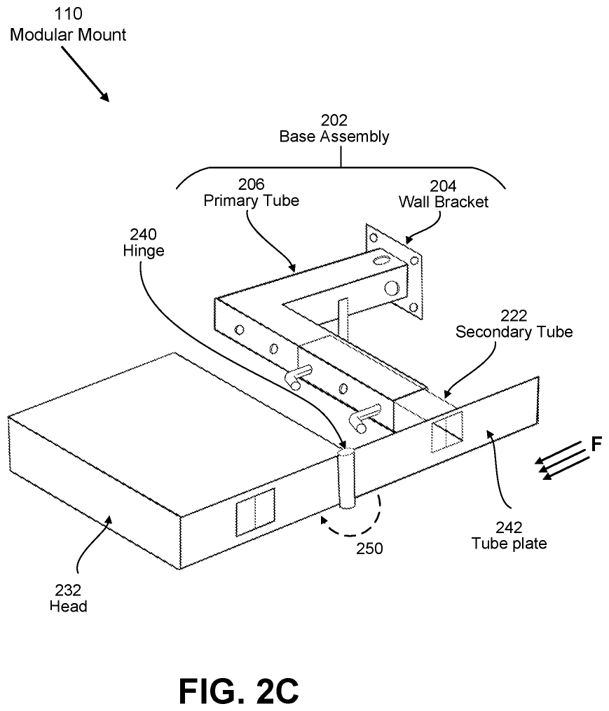

FIG. 2A is an isometric view of an embodiment of modular mount 110. Here modular mount 110 is shown disassembled into two interlocking assemblies: base assembly 202 and head assembly 220. This configuration provides for easy shipping and assembly. In other embodiments, modular mount 110 may be provided as a single, fully assembled, unit. While in other embodiments, when disassembled, modular mount 110 may be in three or more pieces.

Base assembly 202 includes a wall bracket 204, used to attach modular mount to a wall or other surface, and a primary tube 206. Typically wall bracket 204 includes holes for attaching mount 110 to a wall using screws. Alternatively, another attachment mechanism may be used to attach wall bracket 204 to a surface. In certain embodiments wall bracket 204 is a 2.5″ commercial metal bracket, suitable for connecting a 2.5″ square pipe, referred to herein as a tube.

Primary tube 206 connects to wall bracket 204 through a weld or other fastening mechanism. In certain embodiments, primary tube 206 is L-shaped, that is it includes a 90 degree angle, where (1) a 1^{st} part 206a of primary tube 206 attaches to wall bracket 204, and when modular mount 110 is mounted on the wall 2^{nd} part 206a extends in the Y direction perpendicular to the wall, and (2) a 2^{nd} part 206b that forms a 90 degree angle with 1^{st} part 206a and, when modular mount 110 is mounted on the wall, extends in the X direction parallel to the wall. This geometry enables pan 224 to be positioned at a desired distance from wall bracket 204 in the X, Y, and Z directions.

For commercial reasons, base assembly 202 is provided in a variety of sizes and lengths. Tube sizes are typically 2 inches or 2.5 inches. Length of the tube first part is typically. 5-3 feet and lengths of the tube second part are typically 1-6 feet. Other tube sizes and lengths are possible. Further, while tubes are depicted as square in each of the figures herein, rectangular, circular, diamond shaped, or other shaped tubing can be used without departing from the scope of the invention.

At the base of primary tube 206, close to its attachment to wall bracket 204, are one or more knockouts 208, which are typically used as conduit for electrical lines. Knockouts 208 are typically used for low voltage camera/speaker wire and 110V wire for lighting Typically, there are at least two knockouts 208 enabling speaker and camera/speaker to be separated.

A secondary tube 222, attached to pan 224, attaches to primary tube 206, thus connecting head assembly 220 to base assembly 202. In one embodiment, secondary tube 222 fits inside primary tube 206 and the two tubes attach using fasteners 210 that fit through pre-drilled holes in both primary tube 206 and secondary tube 222. During assembly, secondary tube 222 is inserted inside primary tube 206 until one or more of the pre-drilled holes in each tube is aligned and then a fastener, such as a locking pin, is inserted and secured through each pair of aligned holes. Secondary tube 222 can be inserted fully inside primary tube 206 in which case pan 224 is flush or nearly flush with the end of primary tube 206, at the end opposite the end that attaches to wall bracket 204. Secondary tube 222 can also be only partially inserted inside primary tube 206. In other embodiments, primary tube 206 may be inserted inside secondary tube 222.

Cameras, lights, speakers etc. typically mount to the underside of pan 224. Pan 224 houses any camera wiring and network connections while the actual digital video camera mounts below and holes are punched through the bottom of pan 224 to accommodate wiring. There are two wire rings 226 inside of pan 224 that enable two sets of wires to be separated, e.g. a low voltage wire and a 110V wire. The 2 separate inner wire paths lead to two separate conduit knockouts 228 or conduit paths. As illustrated, pan 224 is typically hexahedron shaped and is open at the top. Other shapes, such as a cylinder are also possible without departing from the scope of the invention.

As illustrated in FIG. 2B, when modular mount is fully assembled, a lid 230 covers pan 224. Typically, lid 308 fits over pan 224, as illustrated. The rectangular pan 224 and lid 230 assembly is commonly referred to as head 232. Generally, head 232 offers a serviceable solution to house video, audio, and lighting wiring and network connections. Lid 230 is easily removeable allowing service personnel to access wiring. When assembled, the lid 230 covers pan 234 and is fastened in place. The Lid will be fastened to the head.

Head 232 is fully weatherized. It has a water-impermeable coating and there are gaskets, typically rubber gaskets, between lid 308 and pan 232 that prevent water permeation. For example, in certain embodiments a gasket is installed around the upper perimeter of lid 230 and lid 230 sits atop the gasket. This minimizes permeation of dust, water, and water vapor into the internal volume of head 232.

In this illustration, secondary tube 222 is only inserted part way inside of primary tube 206; the amount of insertion is used to achieve distance and position goals for the placement of head 232.

### Hinge Feature

FIG. 2C illustrates head 232 in a rotated position. This illustrates the function of a hinge 240, which enables head 232 to rotate away from its standard position, which, as illustrated in FIG. 2B, is flush to the end of secondary tube 222 on the side furthest from wall bracket 204. In this embodiment, secondary tube 222 attaches to or is formed integrally with a tube plate 242 that attaches at one end to hinge 240. Head 232 also attaches to hinge 240, either via pan 224 or lid 230. This enables head 232 to rotate or swing outward, i.e. to rotate from its flush position away from secondary tube 222 when force is applied to head 232. Head 232 rotates in the direction in which the force is applied, shown as three parallel lines labeled F, away from its standard position. Dashed semicircle 250 shows the direction of the 180 degree outward rotation of head 232. In other embodiments, the rotation of head 232 may be limited to less than 180 degrees or may exceed 180 degrees.

With reference to the axes of FIG. 1, secondary tube 222 extends along the X dimension and when force is applied to head 232 in the direction of the Y axis, away from the wall, then head 232 rotates up to 180 degrees away from the wall.

Hinge 240 is typically an industrial strength self-closing hinge, which maintains head 232 in contact with tube plate 242. Thus, in the event that force is applied to head 232 and it rotates outward, away from secondary tube 222 it will then return to its standard position, in contact with tube plate 242. Self closing hinges such as hinge 240 are commercially available and typically are spring loaded with adjustable tension. Thus, a minimum force is required to open the hinge.

Typically, head 232, hinge 240, tube plate 222 and secondard tube 222 are provided as one unit, i.e. head assembly 220.

The purpose of the hinge feature is to prevent modular mount 110 from being ripped of the wall in the event that a forklift or a palette or other object being carried by a forklift strikes head 232. In such a case, head 232 rotates outward away from the object that is striking but modular mount 110 doesn't sustain damage, aside from minor scratches. As illustrated in FIG. 2C

In certain embodiments, each of the parts of modular mount 110 is made of metal that that is coated with an anti-rust treatment. In other embodiments, certain parts are made of plastic or another substance.

Upon reading this disclosure, those of skill in the art will appreciate that while particular embodiments and applications have been illustrated and described herein, the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A modular mount for mounting a video cameras and other equipment to a wall, comprising:
a base assembly, comprising:
a wall bracket used to attach the modular mount to a wall, and
a primary tube, attached to the wall bracket; and
a head assembly, comprising:
a secondary tube, with two ends, wherein the first end fastens to the primary tube; and
a head, attached to the the second end of the secondary tube, comprising:
a pan attached to the secondary tube, enabling a video camera and any other equipment to mount to the underside of the pan; and
a lid that covers the pan.

2. The modular mount of claim 1, wherein:
the lid and the secondary tube each attach to a hinge, wherein, in the event that modular mount is mounted to the wall, when greater than a specified force is applied to the head in a direction outward from the wall the head rotates outward and away from the secondary tube.

3. The modular mount of claim 1, wherein the primary tube is L-shaped and comprises:
a 1^{st} part that attaches to the wall bracket and, when the modular mount is mounted on the wall, extends perpendicular to the wall, and
a 2^{nd} part connected to the 1^{st} part and which forms a 90 degree angle with the first part.

4. The modular mount of claim 3 wherein the secondary tube fits inside of or outside of the 2^{nd} part of the primary tube and the secondary tube and the primary tube are fastened by aligning pre-drilled holes in each of the two tubes and inserting fasteners through the pre-drilled holes.

5. The modular mount of claim 1, wherein when the head is in the shape of a hexahedron.

6. The modular mount of claim 1. wherein a gasket is fitted to the upper perimeter of the pan the lid fits on top of the gasket.

7. The modular mount of claim 1, wherein the secondary tube comprises a conduit that may be used to separate electrical wires.
